(19) United States
(12) Patent Application Publication
(10) Pub. No.: US 2025/0071255 A1
(43) Pub. Date: Feb. 27, 2025

(54) METHODS, SYSTEMS, AND APPARATUSES FOR MAINTAINING STEREO CONSISTENCY

(71) Applicant: Apple Inc., Cupertino, CA (US)

(72) Inventors: Jacob Wilson, San Francisco, CA (US); Sushant Ojal, Sunnyvale, CA (US); Seyedkoosha Mirhosseini, Santa Clara, CA (US)

(21) Appl. No.: 18/773,732

(22) Filed: Jul. 16, 2024

Related U.S. Application Data
(60) Provisional application No. 63/534,260, filed on Aug. 23, 2023.

(51) Int. Cl. H04N 13/398; G06T 5/70; G06T 17/00; H04N 13/351

(52) U.S. Cl. CPC H04N 13/398; G06T 5/70; G06T 17/00; H04N 13/351

(57) ABSTRACT

Various examples disclosed herein maintain stereo consistency in extended reality (XR) environments when receiving content data with a content frame depicting both a left eye portion of a content item corresponding to a first left eye viewpoint of the content item within the XR environment, and a right eye portion of the content item corresponding to a first right eye viewpoint of the content item within the XR environment. Stereo consistency may be maintained by determining to use an adjusted version of the content frame to provide a view of the content item wherein a left eye view from a second left eye viewpoint is different than the first left eye viewpoint and a right eye view from a second right eye viewpoint is different than the first right eye viewpoint, and presenting the left eye view and the right eye view based on the content frame and the adjustment.

### CROSS-REFERENCE TO RELATED APPLICATIONS

This Application claims the benefit of U.S. Provisional Application Ser. No. 63/534,260 filed Aug. 23, 2023, which is incorporated herein in its entirety.

### TECHNICAL FIELD

The present disclosure generally relates to methods, systems, and apparatuses for maintaining stereo consistency.

### BACKGROUND

Various techniques are used to provide content to users of display devices. In some techniques, separate content is provided to each eye of a user (e.g., stereoscopic content). Stereoscopic differences between views provided to the left and right eyes can provide the appearance of depth within displayed content. Stereoscopic differences may be used in displaying views of 3D content depicting 3D environments or views of 2D content at 3D positions and orientations within 3D environments. Slightly different views of content corresponding to right and left eye viewpoint positions may be viewed simultaneously, e.g., providing an appearance of depth using left and right eye views corresponding to slightly different viewpoint positions relative to a depicted 3D environment.

Stereo image-based display techniques may be susceptible to issues relating to changing viewpoints and/or reductions in framerate. For example, such techniques may not be well suited for an extended reality (XR) viewing environment in which a 3D video or other changing content is positioned at a fixed 3D position and orientation for the user to view from different viewpoints at various points in time, especially when frames of the 3D video or other changing content are dropped/late or framerate slows down requiring reuse of prior frames for viewpoint positions other than those for which the prior frames were created.

### SUMMARY

Various examples disclosed herein include devices, systems, and methods that display multi-dimensional content (e.g., 1D+ geometry, images, videos, etc.) at a position within a multi-dimensional (e.g., 3D) environment and provides different types of views of the multi-dimensional content item based on various criteria. For example, the type of view may differ based on the viewer/head position and/or the multi-dimensional content item location within the 3D environment. Additionally, various examples disclosed herein correct or otherwise adjust such multi-dimensional content for stereo consistency when the type of view and/or when missing or late frames creates inconsistency between each of the user's eyes.

In some examples, the disclosed devices, systems, and methods provide stereo consistency in circumstances in which the need to reuse a content item from a previous frame would otherwise result in stereo inconsistency, e.g., otherwise result in objectionable differences between what is displayed to the right and left eyes. For example, stereo consistency may be provided in circumstances in which (a) a client (e.g., app) is providing eye-specific frame-based content based on which portions of client content are within each eye's current view of an XR environment; (b) reuse of the client's previous frame content is needed (e.g., due to client delay in providing frames at a display frame rate); and (c) an XR viewpoint change (i.e., between the viewpoint used to generate the content frame being reused and the viewpoint of the view in which the content frame is being reused) is significant enough to result in stereo inconsistency (e.g., one eye sees a region of space occupied by content and the other eye sees the region of space as empty). Stereo inconsistency may be reduced/avoided by reprojecting the content associated with one eye to the other eye (e.g., extending the right eye content using content from the left eye content), cropping (e.g., reducing the left eye content to match the right eye content), and/or a combination. The client content may be faded or frozen to further reduce noticeability of the previous frame reuse and/or any stereo inconsistency resulting therefrom.

An example method may comprise, at a processor, receiving multi-frame content data from a source (e.g., a client app). The multi-frame content data may comprise a content frame depicting a left eye portion of a content item and a right eye portion of the content item. The left eye portion of the content item may correspond to a first left eye viewpoint of the content item positioned within an extended reality (XR) environment. The right eye portion of the content item may correspond to a first right eye viewpoint of the content item within the XR environment. In some examples, each content item may be displayed as part of a corresponding display frame. At a given time, a first frame of the multi-frame content item may be displayed and at a subsequent time a second frame of the multi-frame content item may be displayed. At each point in time, a new frame may be received from a source, e.g., a client, and displayed. At each point in time, a frame's left and right eye portions may be received and displayed. If a frame of the multi-frame content is not received in time to be displayed for a current point in time, e.g., for a current display frame, a previously-received content frame may be reused. However, when reuse of a content frame is required, the content frame may no longer correspond to a current XR viewpoint (e.g., the new left and right eye view points associated with the current display frame), which may, if not addressed, result in inaccurate content positioning and/or stereo inconsistencies. Reused frame content may be adjusted to address content positioning discrepancies (e.g., by warping or shifting the prior frame content) and/or stereo inconsistencies (e.g., by adjusting the left and/or right eye content to be consistent, e.g., depicting regions of 3D space consistently).

Accordingly, the example method may determine to use (or reuse) the previous content frame to provide a view of the content item within the XR environment. In some examples, the view may comprise a left eye view from a second left eye viewpoint different than the first left eye viewpoint and a right eye view from a second right eye viewpoint different than the first right eye viewpoint. In some examples, determining to use the previous content frame may be based on determining that a first frame rate associated with the content item is less than a target frame rate (e.g., a display's frame rate) by a threshold amount (e.g., the client application stops rendering or rendering slows down below 90 Hz). In some examples, determining to use the previous content frame may be based on a delay since receipt of the last received frame being longer than a threshold amount of time (e.g., 0.1-0.2 seconds). In some examples, the threshold amount may be represented as a percentage (e.g., ten percent) or a number of frames (e.g., 9 frames). In some examples, determining to use the previous content frame may be based on identification of reprojection artifacts (e.g., holes in information relating to objects when there is a perspective change).

The example method may determine an adjustment to reduce (or eliminate) an inconsistency associated with the left eye view and the right eye view, wherein a region of the content item in both the left eye view and the right eye view is depicted in only one of the left eye portion and the right eye portion of the content frame. For example, the method may determine that the data for one eye depicts a region of the content item that the data for the other eye does not (e.g., one eye depicts a full picture whereas another eye only sees a partial picture). The method may present the left eye view and the right eye view based on the content frame and the adjustment. In some such examples, stereo inconsistency may be avoided by reprojecting the content associated with one eye to the other eye (e.g., extending one eye's content using content from the other eye), cropping (e.g., reducing one eye's content to match the other eye's content), and/or a combination. In some such examples, the client content be faded or frozen to further reduce noticeability of a previous frame's reuse and/or any stereo inconsistency resulting therefrom.

An example computer readable medium may store computer executable program instructions that, when executed, cause receiving multi-frame content data from a source, the multi-frame content data comprising a content frame: depicting a left eye portion of a content item, the left eye portion corresponding to a first left eye viewpoint of the content item positioned within an extended reality (XR) environment, and depicting a right eye portion of the content item, the right eye portion corresponding to a first right eye viewpoint of the content item within the XR environment; determining to use the content frame to provide a view of the content item within the XR environment, the view comprising a left eye view from a second left eye viewpoint different than the first left eye viewpoint and a right eye view from a second right eye viewpoint different than the first right eye viewpoint; determining an adjustment to reduce an inconsistency associated with the left eye view and the right eye view, wherein a region of the content item in both the left eye view and the right eye view is depicted in only one of the left eye portion and the right eye portion of the content frame; and presenting the left eye view and the right eye view based on the content frame and the adjustment.

An example apparatus may comprise one or more processors and memory storing instructions that, when executed by the one or more processors, cause receiving multi-frame content data from a source, the multi-frame content data comprising a content frame: depicting a left eye portion of a content item, the left eye portion corresponding to a first left eye viewpoint of the content item positioned within an extended reality (XR) environment, and depicting a right eye portion of the content item, the right eye portion corresponding to a first right eye viewpoint of the content item within the XR environment; determining to use the content frame to provide a view of the content item within the XR environment, the view comprising a left eye view from a second left eye viewpoint different than the first left eye viewpoint and a right eye view from a second right eye viewpoint different than the first right eye viewpoint; determining an adjustment to reduce an inconsistency associated with the left eye view and the right eye view, wherein a region of the content item in both the left eye view and the right eye view is depicted in only one of the left eye portion and the right eye portion of the content frame; and presenting the left eye view and the right eye view based on the content frame and the adjustment.

In some examples, the multi-frame content data may be associated with a first frame rate, and wherein the determining to use the content frame to provide the view of the content item within the XR environment is based on determining that the first frame rate is less than a target frame rate (e.g., 90 Hz) by the threshold amount.

In some examples, when the second left eye viewpoint and the second right eye viewpoint are rightward of the first left eye viewpoint and the first right eye viewpoint, the region of the content item in both the left eye view and the right eye view may be depicted in only the left eye portion of the content frame (e.g., the left eye sees more of the content than the right eye when looking to the right of where the content was originally being rendered).

In some examples, when the second left eye viewpoint and the second right eye viewpoint are leftward of the first left eye viewpoint and the first right eye viewpoint, the region of the content item in both the left eye view and the right eye view may be depicted in only the right eye portion of the content frame (e.g., right eye sees more of the content than the left eye when looking to the left of where the content was originally being rendered).

In some examples, the left eye view and/or the right eye view are blurred.

In some examples, the left eye view and/or the right eye view are faded.

Some examples further comprise displaying a left eye view from the first left eye viewpoint and a right eye view from the first right eye viewpoint. In some examples, this display may be presented before presenting the left eye view and the right eye view based on the content frame and the adjustment, such that the presenting the left eye view and the right eye view based on the content frame and the adjustment is a reprojection.

In some examples, presenting the left eye view and the right eye view based on the content frame and the adjustment may comprise presenting, for both the left eye view and the right eye view, only a region of the content item that is depicted in both of the left eye portion and the right eye portion of the content frame (e.g., only displaying the portion of the content item common to both left and right eye portions). For example, where the left eye sees five fingers and the right eye sees three fingers, only three fingers may be presented. In some such examples, both eyes may be presented with content that only one eye would see, that content corresponding to the eye that would see less content (e.g., three out of five fingers).

In some examples, presenting the left eye view and the right eye view based on the content frame and the adjustment may comprise presenting, for both the left eye view and the right eye view, both a region of the content item that is depicted in both of the left eye portion and the right eye portion of the content frame (e.g., content common to both left and right eye portions) and the region of the content item that is depicted in only one of the left eye portion and the right eye portion of the content frame (e.g., content only presented to one eye). In some such examples, both eyes may be presented with content that only one eye would see, that content corresponding to the eye that would see more content (e.g., five out of five fingers).

In some examples, presenting the left eye view and the right eye view may comprise presenting a three-dimensional version of the content item.

In some examples, presenting the left eye view and the right eye view may comprise presenting a static two-dimensional version of the content item.

### BRIEF DESCRIPTION OF THE DRAWINGS

So that the present disclosure can be understood by those of ordinary skill in the art, a more detailed description may be had by reference to aspects of some illustrative examples, some of which are shown in the accompanying drawings.

FIG. 1 is a block diagram that illustrates an example device for generating display data of multi-dimensional content in accordance with examples disclosed herein.

FIG. 2 is a block diagram that illustrates an example display of stereo inconsistent data for different eyes of a user in accordance with examples disclosed herein.

FIG. 3 is a block diagram that illustrates an example generation of a first view of display data of multi-dimensional content for different eyes of a user in accordance with examples disclosed herein.

FIG. 4 is a block diagram that illustrates an example generation of a second view of display data of multi-dimensional content for different eyes of a user in accordance with examples disclosed herein.

FIG. 5 is a block diagram that illustrates an example generation of a third view of display data of multi-dimensional content for different eyes of a user in accordance with examples disclosed herein.

FIG. 6 is a block diagram that illustrates an example generation of a fourth view of display data of multi-dimensional content for different eyes of a user in accordance with examples disclosed herein.

FIG. 7 is a flowchart representative of an exemplary method that provides an adjustment for stereo inconsistency in accordance with examples disclosed herein.

FIG. 8 is a block diagram of an exemplary device in accordance with examples disclosed herein.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

In some examples, electronic devices may be capable of presenting multi-dimensional content within extended reality (XR) environments. Multi-dimensional content may be statically displayed within an XR environment over time (e.g., a same image is displayed in every frame) or may vary (e.g., new images are displayed in different frames). In some examples, a user may adjust his or her field-of-view (FOV) so that multi-dimensional content may appear in a different location relative to the user's field of view. For example, content that may be presented initially directly in front of a user may appear to the user's left if the user's FOV is moved to the right. Likewise, content presented initially directly in front of a user may appear to the user's right if the user's FOV is moved to the left.

In some examples, a source of multi-dimensional content may fail to provide one or more frames (e.g., dropped frames), may provide one or more frames late (e.g., the timestamp associated with when the content should be displayed has already passed), or may fail to provide frames at a target framerate. In some examples, a previously rendered content frame may be used to correct dropped frames, late frames, or content provided at an inadequate framerate. In some examples, dropped frames, late frames, or inadequate framerate issues may occur in association with a user changing his or her FOV. In some examples, dropped frames, late frames, or inadequate framerate issues may occur in association with the display of content near a user's peripherals. In some such examples, if a previously rendered content frame is used to render an additional frame for a user's current view to account for the dropped/late frames or inadequate framerate, and if the user changes his or her FOV, the rendered content may be incomplete in one or more eyes. In such examples, the left and right eyes of a user may not be looking at the same content and stereo inconsistencies may develop.

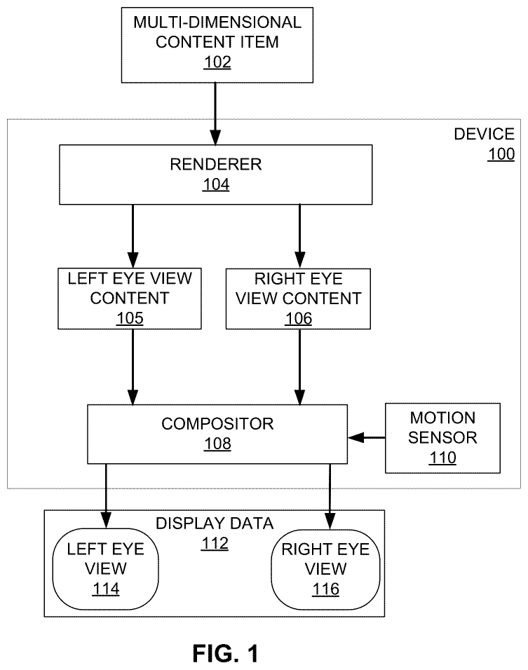

As set forth herein, devices, systems, and methods are disclosed to identify, adjust, and correct any stereo inconsistencies. FIG. 1 illustrates an example device 100 that may prepare and present multi-dimensional content to a user in accordance with examples disclosed herein. The example device 100 may be a handheld electronic device (e.g., a smartphone or a tablet). In some examples, the device 100 may be a near-eye device such as a head worn device (e.g., a head mounted device (HMD)). The device 100 may utilize one or more display elements to present views of multi-dimensional content to a user. For example, the device 100 may display views that include 3D content in the context of an extended reality (XR) environment. In some examples, the device may enclose the FOV of a user. In some implementations, the functionalities of the device 100 are provided by more than one device. In some examples, the device 100 may communicate with a separate controller or server to manage and coordinate an experience for the user. Such a controller or server may be located in or may be remote relative to the physical environment.

The physical environment may be a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment may be a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There may be many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some examples, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

In some examples, a multi-dimensional content item 102 may be provided to the device 100 via a source. In some examples, multiple sources may provide multi-dimensional content items 102 to the device 100. In some examples, the multi-dimensional content item 102 may be provided by a third party. In some examples, the multi-dimensional content item 102 may be provided by a client application. In some examples, the multi-dimensional content item 102 may be a two or three-dimensional image or video. In some examples, the multi-dimensional content item 102 comprises both left eye view content and right eye view content. In some such examples, even two-dimensional images or videos may be presented with the illusion of depth based on slight differences in perspectives in the left eye view content and the right eye view content (e.g., stereoscopy). In some examples, the multi-dimensional content item 102 may be associated with a particular framerate in which the content should be presented. In some examples, the multi-dimensional content item 102 has timestamps associated with particular presentation times. In some examples, the multi-dimensional content item 102 may be associated with particular coordinates in the physical or XR environment.

As shown in FIG. 1, the multi-dimensional content item 102 may be an input to a renderer 104. In some examples, each multi-dimensional content item 102 may be associated with a respective renderer 104. In some examples, a single renderer 104 may receive multiple multi-dimensional content from one or more sources. The renderer 104 may generate the XR environment and any content to be presented within the XR environment. In some examples, the renderer 104 may generate left eye view content 105 and right eye view content 106. In some examples, the renderer 104 may generate the left eye view content 105 and the right eye view content 106 for each display frame. In some examples, the renderer 104 only renders for display a portion of the XR environment and any associated content that would fit within a user's FOV (e.g., what would fit within one or more physical displays). In some examples, the renderer 104 pre-renders (prepares but does not display) the XR environment and any associated content outside of a user's FOV. In some such examples, when the user changes his or her FOV, additional portions of the XR environment and any associated content within the new FOV may be efficiently rendered for display to the user. The left eye view content 105 and the right eye view content 106 may be input into a compositor 108.

In some examples, the renderer 104 may miss one or more content frames (e.g., drop one or more frames) of the multi-dimensional content item 102. In some examples, this may be due to a delayed or lack of provision of content from a source, errors in rendering, lack of resources, or the like. In some such examples, the compositor 108 may reproject the previously rendered content frame to make up for missing content frames. In some examples, the compositor 108 may reproject previously reprojected content frames (e.g., reprojecting a reprojection of a previously rendered content frame). In some examples, the compositor 108 may adapt or otherwise transform the previously rendered or reprojected content frame according to a new perspective, such as when a user changes his or her FOV. The device 100 may detect when a user changes his or her FOV using a motion sensor 110. The motion sensor 110 may be an inertial measurement unit (IMU), an accelerometer, a magnetometer, a gyroscope, a haptics engine, one or more depth sensors (e.g., a structured light, a time-of-flight, or the like), and/or any other known sensor for detecting motion, movement, and/or other spatial changes. Data from the motion sensor 110 may be input into the compositor 108.

The compositor 108 may generate display data 112 based on at least the multi-dimensional content item 102, the left eye view content 105, the right eye view content 106, the XR environment, and/or data from the motion sensor 110. In some examples, the compositor 108 may combine rendered content from a plurality of sources (e.g., multiple different left eye view and right eye view content) to generate the display data 112. As disclosed herein, the compositor 108 may, for each of the different sources of rendered content, independently provide adjustments to respective left and/or right eye view content from the respective sources when generating the display data 112.

The display data 112 may include images/videos for display to the user. The compositor 108 may use the left eye view content 105, the right eye view content 106, the framerate, the presentation times, the particular coordinates associated with the physical or XR environment, and/or the data from the motion sensor 110 to spatially and/or temporally present the display data 112 to the user within the physical or XR environment. For example, a photograph may be displayed to a user that isn't physically there. In some examples, the photograph may be displayed directly in front of the user's FOV initially, and may remain static in that space despite the user changing the user's FOV such as by moving the device 100. In some examples, the photograph may move throughout the XR environment without the user changing his or her FOV. In some examples, the compositor 108 may generate both a left eye view 114 and a right eye view 116. In some examples, the left eye view 114 and the right eye view 116 have slightly different perspectives to give the appearance of depth to the display data 112 (e.g., stereoscopy). In some examples, the left eye view 114 and the right eye view 116 together provide a multi-dimensional view of the display data 112 (e.g., three-dimensions with respect to space, four-dimensions with respect to space and time). In some examples, the compositor 108 generates the display data 112 at a first framerate.

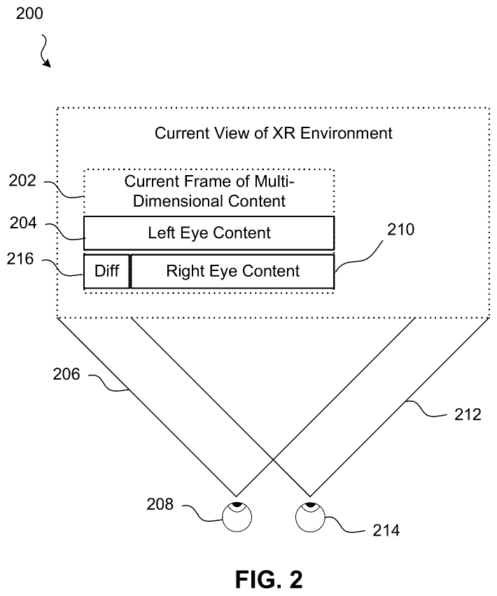

Because the eyes of a user naturally have different perspectives, there may be instances in which content in the left eye view 114 differs significantly from content in the right eye view 116. For example, when content is presented at a user's peripherals, the content may be partially or completely obstructed or otherwise not visible in one of the left eye or the right eye. As illustrated in FIG. 2, a current view 200 of an XR environment may be presented to a user. Within the current view 200, the device 100 may present a current frame 202 of the multi-dimensional content item 102. In accordance with the discussion relating to FIG. 1, the current frame 202 may comprise both a left eye view content 204 viewable within a left eye view 206 of a left eye 208, and a right eye view content 210 viewable within a right eye view 212 of a right eye 214. As shown in FIG. 2, the left eye content 204 exceeds the right eye view 212 by a difference (“Diff”) 216, such that the current frame 202 is only partially visible to the right eye 214 (even though the current frame is completely visible to the left eye 208. In such examples, the left eye 208 and the right eye 214 may not be looking at the same content and stereo inconsistencies may develop. In some such examples, the stereo inconsistencies may make the XR experience unpleasant to a user.

As disclosed herein, the compositor 108 may make an adjustment to reduce or eliminate any such stereo inconsistencies. In some examples, the compositor 108 may determine to, in addition to reprojecting the left eye content 204 to the left eye 208, reproject the left eye content 204 when reprojecting for the right eye 214, effectively eliminating the difference 216. In some examples, the compositor 108 may determine to reproject a portion of the left eye content 204 corresponding to the difference 216 and use the reprojected portion of the left eye content in combination with reprojected right eye content 210 to extend the right eye content 210 to match the left eye content 204. In some such examples, the extended right eye content 210 may still not be completely viewable within the right eye view 212 of the right eye 214. In some examples, the compositor 108 may determine to crop or otherwise cut off a portion of the left eye content 204 corresponding to the difference 216, thereby making the left eye content 204 match the right eye content 210. In some examples, the compositor 108 may freeze or fade the left eye content 204 and/or the right eye content 210. Of course, reference to the left eye and the right eye in the above examples may be reversed if content is presented such that the right eye content exceeds the left eye view.

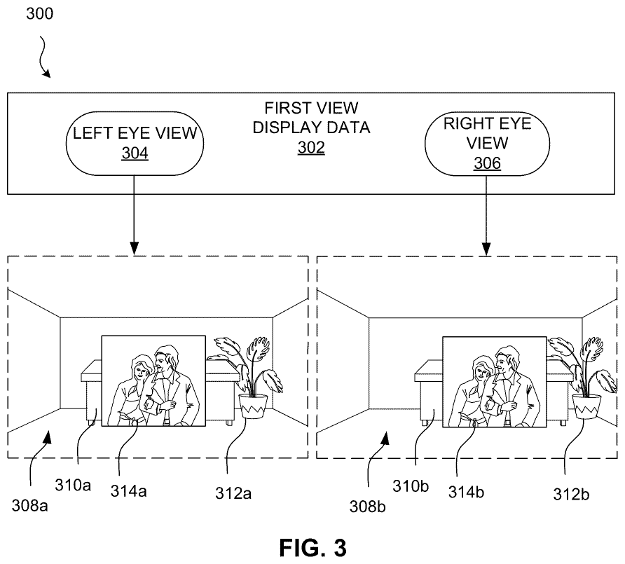

FIGS. 3-6 illustrate an example situation in which a stereo inconsistency may develop and how the compositor 108 may make an adjustment to reduce or eliminate the stereo inconsistency. As shown in FIG. 3, at a first point in time 300, the compositor 108 may generate a first view 302 of display data of the multi-dimensional content item 102 comprising both a left eye view 304 and a right eye view 306. The first view 302 may comprise a single frame of content. In some examples, the first view 302 comprises several frames of content displayed at a framerate (e.g., 90 Hz).

The left eye view 304 may comprise a view of an XR environment including a room 308a with a desk 310a and a plant 312a. In some examples, the room 308a, the desk 310a, and the plant 312a may be permanent features of the XR environment. In some examples, the room 308a, the desk 310a, and the plant 312a may be physical objects in a physical environment that are viewable within the XR environment. In some examples, the room 308a, the desk 310a, and the plant 312a may be virtual objects created and displayed by device 100. In some examples, the left eye view 304 may contain another object 314a. In some examples, the object 314a may be virtual content created by a source (e.g., a client app). In the example illustrated in FIG. 3, the object 314a may be a photograph of a man and a woman walking arm in arm. In some examples, the object 314a may be a video of a man and a woman walking arm in arm.

The right eye view 306 may comprise a similar view of the XR environment as the left eye view 304, but with a slightly different perspective. In some examples, the right eye view 306 may include similar features as the left eye view 304 such as, for example, a room 308b with a desk 310b and a plant 312b. In some examples, the room 308b, the desk 310b, and the plant 312b may be permanent features of the XR environment. In some examples, the room 308b, the desk 310b, and the plant 312b may be physical objects in a physical environment that are viewable within the XR environment. In some examples, the room 308b, the desk 310b, and the plant 312b may be virtual objects created and displayed by device 100. In some examples, the right eye view 306 may contain another object 314b. In some examples, the object 314b may be virtual content created by a source (e.g., a client app). In the example illustrated in FIG. 3, the object 314b may be a photograph of a man and a woman walking arm in arm. In some examples, the object 314b may be a video of a man and a woman walking arm in arm. In some examples the compositor 108 may present the objects 314a, 314b spatially and temporally within the XR environment. For example, the compositor 108 may present the objects 314a, 314b in a particular space in the XR environment (e.g., floating in front of the desks 310a, 310b, and floating in front of and to the left of the plants 312a, 312b). Such presentation may be static, such that if the user were to change his or her FOV, the objects 314a, 314b would not move within the XR environment as the user moves his or her FOV. Additionally, the compositor 108 may present the objects 314a, 314b at a particular time and for a particular duration (e.g., the objects 314a, 314b may not be permanently presented to the user).

Due to the slightly different perspectives of the left eye view 304 and the right eye view 306 (e.g., the desk 310a, the plant 312a, and the object 314a may appear more leftward in the room 308a and the desk 310b, the plant 312b, and the object 314b may appear more rightward in the room 308b), a user viewing both the left eye view 304 and the right eye view 306 with the left and right eyes of the user will be able to see a version of the first view 302 with the appearance of depth (e.g., crossing one's eyes when viewing the left eye view 304 and right eye view 306 of FIG. 3 may illustrate this particular effect).

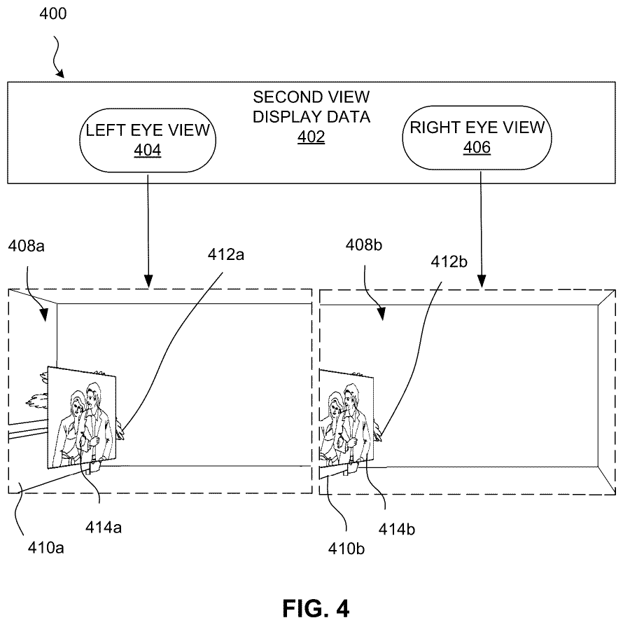

As shown in FIG. 4, at a second point in time 400, the user may have adjusted his or her FOV (e.g., by looking to the right of the first view 302). In some examples, the compositor 108 may generate a second view 402 of the display data comprising both a left eye view 404 and a right eye view 406. Similar to the discussion above with respect to FIG. 3, the left eye view 404 may comprise a view of the XR environment including a room 408a with a desk 410a, a plant 412a, and an object 414a, and the right eye view 406 may include similar features as the left eye view 404 such as, for example, a room 408b with a desk 410b, a plant 412b, and an object 414b.

Due to the user having adjusted his or her FOV (e.g., turning to the right), the desks 410a, 410b, the plants 412a, 412b, and the objects 414a, 414b may be presented leftward within the rooms 408a, 408b. And, due to the different perspectives of the left eye view 404 and the right eye view 406, the object 414b may not be completely displayed within the right eye view 406 (the desks 410a, 410b and the plant 412b may similarly not be completely displayed in the left eye view 404 or the right eye view 406). If, between the first view 302 and the second view 402, frames of the content are dropped, arrive late, or are presented at a framerate lower than the target framerate, then the compositor 108 may have to rely on a previously rendered content frame. In some such examples, the compositor 108 may use, reuse, or otherwise reproject a previous frame to avoid gaps in presentation of the multi-dimensional content item 102.

To determine whether frames of content are dropped, late, or at a framerate lower than the target framerate, the compositor 108 may perform a threshold analysis. In some examples, the compositor 108 may compare the timestamps associated with when the content should be displayed with a rendering timestamp for displaying the content. In some such examples, the compositor 108 may determine whether such timestamps differ by a threshold amount of time (e.g., 0.1 seconds). In some examples, the compositor 108 may compare a framerate associated with the multi-dimensional content item 102 to a target framerate (e.g., 90 Hz) and determine whether the framerates differ by a threshold amount (e.g., 10 percent). In some examples, the compositor 108 may compare a number of provided frames of the multi-dimensional content item 102 to a target number of frames for a given time (e.g., 90 frames within a second) and determine whether the number of provided frames differ from the target number of frames by a threshold amount (e.g., 9 frames).

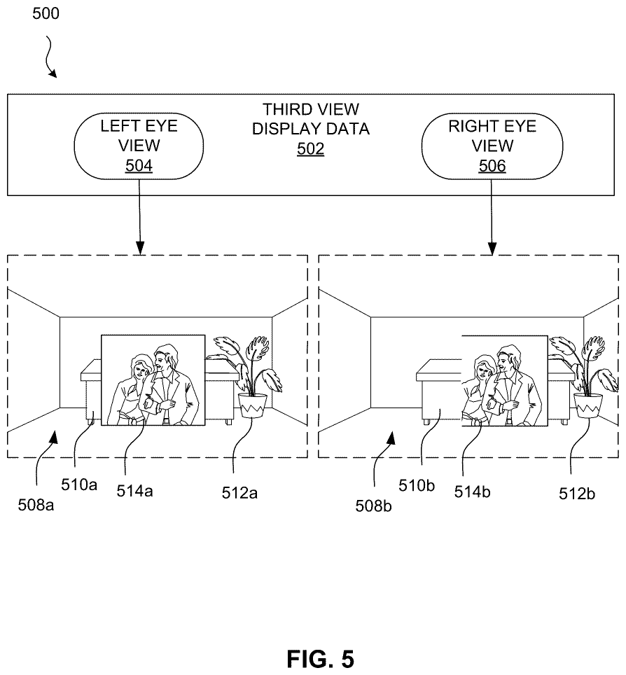

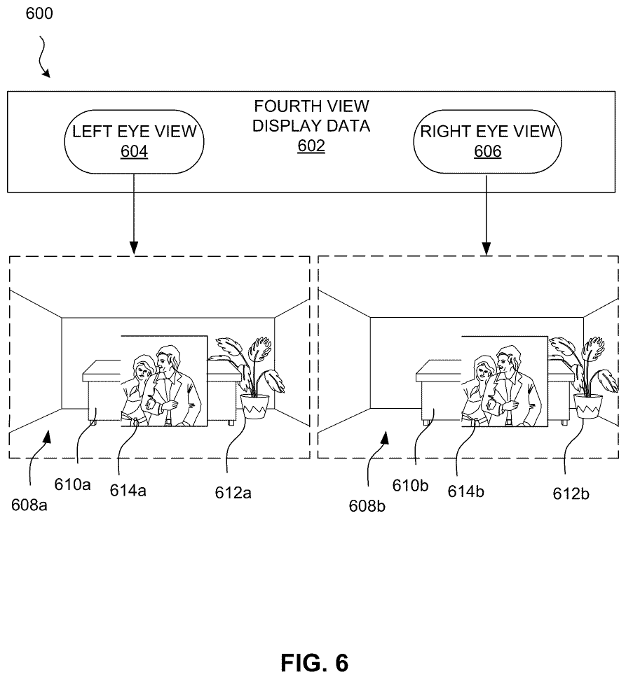

If the user were to readjust his or her FOV (e.g., turning left and returning to the original FOV) while the device 100 is using a previously rendered content frame or a previously reprojected content frame, the previously rendered content frame or previously reprojected content frame may be incomplete within the new FOV as illustrated in FIG. 5. For example, FIG. 5 illustrates that, at a third point in time 500, the user may have readjusted his or her FOV to return to the previous FOV (e.g., as previously illustrated in FIG. 3). The compositor 108 may generate a third view 502 of the display data comprising both a left eye view 504 and a right eye view 506. Similar to the discussion above with respect to FIGS. 3-4, the left eye view 504 may comprise a view of the XR environment including a room 508a with a desk 510a, a plant 512a, and an object 514a, and the right eye view 506 may include similar features as the left eye view 504 such as, for example, a room 508b with a desk 510b, a plant 512b, and an object 514b. However, because the third view 502 of the display data is relying upon a previously rendered content frame or a previously reprojected content frame, the object 514b may not be rendered completely (e.g., the woman's shoulder and arm may be missing from the photograph/video of the man and woman walking arm in arm) because the object 414b of the right eye view 406 of second view 402 was not rendered completely due to the content being partially outside of the user's right eye view 406. In examples wherein the desks 510a, 510b, and the plants 512a, 512b are part of the XR or physical environment, such stereo inconsistencies may not occur with respect to these objects. In other examples, similar stereo inconsistencies may form between the desk 510a from the left eye view 504 and the desk 510b from the right eye view 506, and/or between the plant 512a from the left eye view 504 and the plant 512b from the right eye view 506.

Where the content differs between eyes of a user, stereo inconsistencies may develop and may cause user discomfort or sensitivity, and may otherwise make the XR experience unpleasant to the user. The compositor 108, therefore, may determine to make an adjustment to the previously rendered or reprojected content frame prior to its (re)use. For example, the compositor 108 may determine to crop content within one of a left eye view or a right eye view to match an incompletely rendered content item. As shown in FIG. 6, rather than display the third view 502 at time 500, at time 600 (e.g., the same time as time 500) the compositor 108 may present a fourth view 602 of the display data comprising both a left eye view 604 and a right eye view 606. Similar to the discussions above with respect to FIGS. 3-5, the left eye view 604 may comprise a view of the XR environment including a room 608a with a desk 610a, a plant 612a, and an object 614a, and the right eye view 606 may include similar features as the left eye view 604 such as, for example, a room 608b with a desk 610b, a plant 612b, and an object 614b. However, the compositor 108 may crop a portion of the left eye view 604 such that the object 614a is not rendered completely (e.g., cropping the woman's shoulder and arm from the photograph/video of the man and woman walking arm in arm). The compositor 108 may determine (as similarly described above) that a user may have adjusted his or her viewpoint and may determine that one or more frames were dropped, late, or otherwise provided at an inadequate framerate in view of a threshold analysis. The compositor 108 may further determine that object 614b may not be rendered completely if the previously rendered or reprojected content frame of the object 414b from the prior right eye view 406 of the second view 402 were reprojected in the fourth view 602.

In some examples, the compositor 108 may obtain the previously rendered or reprojected content frame of the object 414a from the prior left eye view 404 of the second view 402. In some examples, the compositor 108 may determine that the previously rendered or reprojected content frame of the object 414a from the prior left eye view 404 of the second view 402 has more data than the previously rendered or reprojected content frame of the object 414b from the prior right eye view 406 of the second view 402. In some examples, the compositor 108 may make such a determination based on determining that the second view 402 is to the right of the first view 302 (e.g., based on differences in head or device pose calculated based on motion sensor data), and therefore determine that the left eye of the user would be able see more data corresponding to a previously displayed content item (that would now be to the left of the user) than the right eye of the user would be able to see (likewise, if a subsequent view was to the left of a former view, the right eye of a user would be able see more data corresponding to a previously displayed content item that would be then be to the right of the user).

In some examples, the compositor 108 may compare the previously rendered or reprojected content frame of the object 414a from the prior left eye view 404 of the second view 402 to the previously rendered or reprojected content frame of the object 414b from the right eye view 406 of the second view 402. The compositor 108 may determine an amount that the object 414a from the left eye view 404 of the second view 402 and the object 414b from the right eye view 406 of the second view 402 overlap (e.g., determine the common content between the object 414a from the left eye view 404 of the second view 402 and the object 414b from the right eye view 406 of the second view 402). In some examples, the compositor 108 may determine the overlapping content to be an adjustment. In some examples, the compositor 108 may crop the object 414a to be equal to the amount that the object 414a and the object 414b overlap. In some examples, the compositor 108 may then use the cropped object as both the object 614a in the left eye view 604 of the fourth view 602 and the object 614b in the right eye view 606 of the fourth view 602, as shown in FIG. 6. In some examples, the compositor 108 may use the cropped object to present the object 614a in the left eye view 604 of the fourth view 602, and may use the object 414b in the right eye view 406 of the second view 402 to present the object 614b in the right eye view 606 of the fourth view 602. In some such examples, the compositor 108 may present the left eye view 604 and the right eye view 606 based on the previously rendered or reprojected content frame and the adjustment. In such examples, both the object 614a in the left eye view 604 of the fourth view 602 and the object 614b in the right eye view 606 of the fourth view 602 may be not completely rendered (e.g., the woman's shoulder and arm may be missing from the photograph/video of the man and woman walking arm in arm), but the incomplete rendering may be consistent between the left eye view 604 and the right eye view 606.

In some examples, the compositor 108 may determine an amount of the object 414a from the left eye view 404 of the second view 402 that does not correspond to the object 414b from the right eye view 406 of the second view 402 (e.g., determine the non-common content between the object 414a from the left eye view 404 of the second view 402 and the object 414b from the right eye view 406 of the second view 402). In some examples, the compositor 108 may determine the non-overlapping content to be an adjustment. In some examples, the compositor 108 may use the amount of the object 414a from the left eye view 404 of the second view 402 that does not correspond to the object 414b from the right eye view 406 of the second view 402 to fill in missing content or gaps in the object 414b from the right eye view 406 of the second view 402. In some such examples, rather than the rendering the fourth view 602, the compositor 108 would generate a view similar to the first view 302 (e.g., the objects within the left and right eye views would both be completely displayed).

In some examples, the compositor 108 may use all of the content of the left eye view or the right eye view in replacement of the right eye view or the left eye view. In some examples, which eye view that is used may be determined based on the user's current FOV compared with the user's previous FOV (e.g., when a subsequent viewpoint is to the left of a previous viewpoint, all of the content of the right eye view may be used, and when a subsequent viewpoint is to the right of a previous viewpoint, all of the content of the left eye view may be used). In some examples, reprojecting the entirety of one eye's content for use in reprojecting content to the other eye may result in the overall content losing stereoscopic depth. In some such examples, the content may appear as two-dimensional frozen pane in the XR environment.

In some examples, the compositor 108 may blur and/or fade content that is subject to missing or late frames or subject to an inadequate framerate. In some such examples, blurring or fading the content may reduce or eliminate stereo inconsistencies by obscuring or removing the inconsistencies.

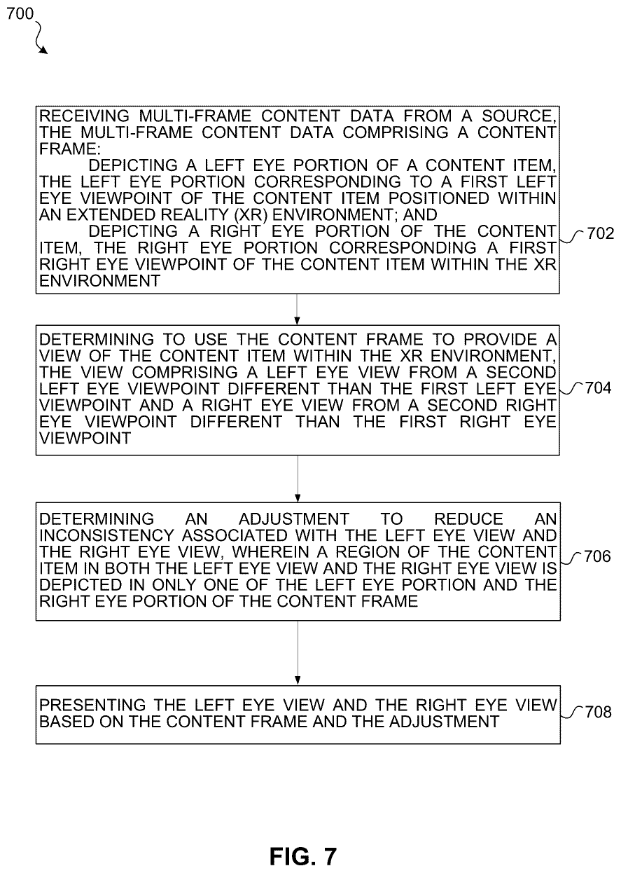

FIG. 7 is a flowchart representative of an exemplary method 700 that may be performed by device 100 to provide an adjustment for stereo inconsistency. The method 700 may begin with block 702 where the compositor 108 may receive multi-frame content data from a source. In some examples, the source may be an application running on the device 100. In some examples, the application may be a third-party application. In some examples, the received multi-frame content data may comprise a content frame depicting a left eye portion of a content item corresponding to a first left eye viewpoint of the content item positioned within an XR environment. In some examples, the received multi-frame content data may comprise a content frame depicting a right eye portion of the content item corresponding to a first right eye viewpoint of the content item within the XR environment. In some examples, each content frame may be displayed as part of a corresponding display frame. For example, content frames may be used in XR views associated with the same viewpoints.

At block 704, the compositor 108 may determine to use (or reuse) the content frame to provide a view of the content item within the XR environment. In some examples, this may be based on the compositor 108 determining that a first frame rate associated with the multi-frame content item is less than a target frame rate (e.g., a display's frame rate) by a threshold amount (e.g., a client application stops rendering or rendering slows down below 90 Hz). In some examples, the compositor 108 may determine that a number of provided frames of the multi-frame content is less than a target number of frames for a given time (e.g., 90 frames within a second) by a threshold amount (e.g., 9 frames). In some examples, the compositor 108 may determine that a timestamp associated with the content frame differs from a timestamp associated a corresponding display frame by a threshold amount of time (e.g., 0.1 seconds).

In some examples, the view that the compositor 108 is to provide may comprise a left eye view from a second left eye viewpoint different than the first left eye viewpoint and a right eye view from a second right eye viewpoint different than the first right eye viewpoint. Due to the possibility of viewpoints changing frequently (e.g., from a user moving his or her head while wearing a head-mounted display, from a user moving around a device displaying views of an XR environment, from a user navigating an XR environment with a controller), reusing prior content frames when frames are dropped, late, or subject to an inadequate framerate, may result in inconsistencies as the prior content frame may no longer correspond to a current XR viewpoint. As described above, the compositor 108 may determine a change in viewpoint based on data from the motion sensor 110.

In some examples, a region of the content item in both the left eye view and the right eye view is depicted in only one of the left eye portion and the right eye portion of the content frame. For example, the compositor 108 may determine that the data for one eye depicts a region of the content item that the data for the other eye does not (e.g., one eye depicts a full picture whereas another eye only sees a partial/no picture). As another example, a left eye of a user may see five fingers of a hand, whereas a right eye of a user may see only three fingers of the hand. Accordingly, at block 706, the compositor 108 may determine an adjustment to reduce (or eliminate) an inconsistency associated with the left eye view and the right eye view.

In some examples, the compositor 108 may determine the adjustment to be a reprojection of content from one eye when reprojecting content to the other eye (e.g., duplication of content). For example, the compositor 108 may reproject the five fingers that the left eye sees when reprojecting to the right eye (e.g., both eyes would see five fingers). In some examples, the compositor 108 may determine the adjustment to be a gap fill using partial content from one eye to complete the content in another eye (e.g., extending one eye's content using content from the other eye). For example, the compositor 108 may identify the two fingers missing from the right eye content within the left eye content, and add those two fingers when presenting the right eye view (e.g., both eyes would see five fingers). In some examples, the compositor 108 may determine the adjustment to be a cropping of content from one eye view (e.g., reducing one eye's content to match the other eye's content). For example, the compositor 108 may remove the two fingers from the left eye view that the right eye view is missing (e.g., both eyes would see the same three fingers). In some examples, the compositor 108 may determine the adjustment to be blurring or fading the content in one or more eye views. In some examples, the compositor 108 may determine the adjustment to be a freezing of content into a two-dimensional static pane. In some examples, the compositor 108 may determine the adjustment to be one or more of the above.

At block 708, the compositor 108 may present the left eye view and the right eye view based on the content frame and the adjustment. In some such examples, stereo inconsistency may be avoided, reduced, or otherwise eliminated. In some examples, the method 700 may be performed whenever the compositor 108 detects the potential for stereo inconsistency (e.g., when there are dropped or late frames or the content is associated with a framerate lower than a display framerate by a threshold amount, when a user's viewpoint is changing, and or content is presented within a user's peripheral vision). In some examples, the method 700 may be performed for each display frame (e.g., up to a target frame rate such as, for example, 90 times per second or 90 Hz).

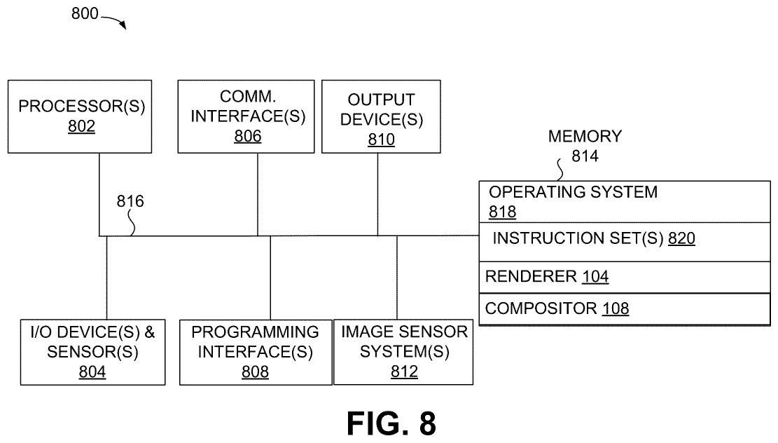

FIG. 8 is a block diagram of electronic device 800. Device 800 illustrates an exemplary device configuration for electronic device 100. While certain specific features are illustrated, those skilled in the art will appreciate from the present disclosure that various other features have not been illustrated for the sake of brevity, and so as not to obscure more pertinent aspects of the examples disclosed herein. To that end, as a non-limiting example, in some examples the device 800 includes one or more processors 802 (e.g., microprocessors, ASICs, FPGAs, GPUS, CPUs, processing cores, and/or the like), one or more input/output (I/O) devices and sensors 804, one or more communication interfaces 806 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 808, one or more output device(s) 810, one or more interior and/or exterior facing image sensor systems 812, a memory 814, and one or more communication buses 816 for interconnecting these and various other components.

In some examples, the one or more communication buses 816 include circuitry that interconnects and controls communications between system components. In some examples, the one or more I/O devices and sensors 804 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some examples, the one or more output device(s) 810 include one or more displays configured to present a view of a 3D environment to the user. In some examples, the one or more output device(s) 810 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some examples, the one or more displays correspond to diffractive, reflective, polarized, holographic, etc. waveguide displays. In some examples, the device 800 includes a display for each eye of the user.

In some examples, the one or more output device(s) 810 include one or more audio producing devices. In some examples, the one or more output device(s) 810 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 810 may additionally or alternatively be configured to generate haptics.

In some examples, the one or more image sensor systems 812 are configured to obtain image data that corresponds to at least a portion of a physical environment. For example, the one or more image sensor systems 812 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various examples, the one or more image sensor systems 812 further include illumination sources that emit light, such as a flash. In various examples, the one or more image sensor systems 812 further include an on-camera image signal processor (ISP) configured to execute a plurality of processing operations on the image data.

The memory 814 includes high-speed random-access memory, such as DRAM, SRAM, DDR RAM, or other random-access solid-state memory devices. In some examples, the memory 814 includes non-volatile memory, such as one or more magnetic disk storage devices, optical disk storage devices, flash memory devices, or other non-volatile solid-state storage devices. The memory 814 optionally includes one or more storage devices remotely located from the one or more processors 802. The memory 814 comprises a non-transitory computer readable storage medium.

In some examples, the memory 814 or the non-transitory computer readable storage medium of the memory 814 stores an optional operating system 818 and one or more instruction set(s) 820. The operating system 818 includes procedures for handling various basic system services and for performing hardware dependent tasks. In some examples, the instruction set(s) 820 include executable software defined by binary information stored in the form of electrical charge. In some examples, the instruction set(s) 820 are software that is executable by the one or more processors 802 to carry out one or more of the techniques described herein. The instruction set(s) 820 may include a renderer 104 to generate left and right eye content based on received multi-dimensional content. The instruction set(s) 820 may include a compositor 108 configured to, upon execution, correct stereo inconsistencies by taking previous frames that were displayed to one eye and reprojecting them to both eyes, freezing previous frames, and/or fading an application causing the stereo inconsistencies, as described herein.

Although the instruction set(s) 820 are shown as residing on a single device, it should be understood that in other examples, any combination of the elements may be located in separate computing devices. Moreover, FIG. 8 is intended more as functional description of the various features which are present in a particular example as opposed to a structural schematic of the examples described herein. As recognized by those of ordinary skill in the art, items shown separately could be combined and some items could be separated. The actual number of instructions sets and how features are allocated among them may vary from one example to another and may depend in part on the particular combination of hardware, software, and/or firmware chosen for a particular example.

It will be appreciated that the examples described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more examples of the present subject matter. Any suitable programming, scripting, or other type of language or combinations of languages may be used to implement the teachings contained herein in software to be used in programming or configuring a computing device.

Examples of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular examples only and is not intended to be limiting of the claims. As used in the description of the examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative examples but according to the full breadth permitted by patent laws. It is to be understood that the examples shown and described herein are only illustrative of the principles of the present invention and that various modification may be implemented by those skilled in the art without departing from the scope and spirit of the invention.

What is claimed is:

1. A method comprising: at a processor:
receiving multi-frame content data from a source, the multi-frame content data comprising a content frame:
depicting a left eye portion of a content item, the left eye portion corresponding to a first left eye viewpoint of the content item positioned within an extended reality (XR) environment; and
depicting a right eye portion of the content item, the right eye portion corresponding to a first right eye viewpoint of the content item within the XR environment; and
determining to use the content frame to provide a view of the content item within the XR environment, the view comprising a left eye view from a second left eye viewpoint different than the first left eye viewpoint and a right eye view from a second right eye viewpoint different than the first right eye viewpoint;
determining an adjustment to reduce an inconsistency associated with the left eye view and the right eye view, wherein a region of the content item in both the left eye view and the right eye view is depicted in only one of the left eye portion and the right eye portion of the content frame; and
presenting the left eye view and the right eye view based on the content frame and the adjustment.

2. The method of claim 1, wherein the multi-frame content data is associated with a first frame rate, and wherein the determining to use the content frame to provide the view of the content item within the XR environment is based on determining that the first frame rate is less than a target frame rate by the threshold amount.

3. The method of claim 2, wherein the threshold amount is ten percent.

4. The method of claim 1, wherein when the second left eye viewpoint and the second right eye viewpoint are rightward of the first left eye viewpoint and the first right eye viewpoint, the region of the content item in both the left eye view and the right eye view is depicted in only in the left eye portion of the content frame.

5. The method of claim 1, wherein when the second left eye viewpoint and the second right eye viewpoint are leftward of the first left eye viewpoint and the first right eye viewpoint, the region of the content item in both the left eye view and the right eye view is depicted in only in the right eye portion of the content frame.

6. The method of claim 1, further comprising blurring the left eye view and the right eye view.

7. The method of claim 1, further comprising displaying a left eye view from the first left eye viewpoint and a right eye view from the first right eye viewpoint.

8. The method of claim 1, wherein presenting the left eye view and the right eye view based on the content frame and the adjustment comprises presenting, for both the left eye view and the right eye view, only a region of the content item that is depicted in both of the left eye portion and the right eye portion of the content frame.

9. The method of claim 1, wherein presenting the left eye view and the right eye view based on the content frame and the adjustment comprises presenting, for both the left eye view and the right eye view, both:
a region of the content item that is depicted in both of the left eye portion and the right eye portion of the content frame, and
the region of the content item that is depicted in only one of the left eye portion and the right eye portion of the content frame.

10. The method of claim 1, further comprising fading the left eye view and the right eye view.

11. The method of claim 1, wherein presenting the left eye view and the right eye view comprises presenting a three-dimensional version of the content item.

12. The method of claim 1, wherein presenting the left eye view and the right eye view comprises presenting a static two-dimensional version of the content item.

13. A device comprising:
one or more processors; and
memory storing instructions that, when executed by the one or more processors, cause performance of operations comprising:
receiving multi-frame content data from a source, the multi-frame content data comprising a content frame:
depicting a left eye portion of a content item, the left eye portion corresponding to a first left eye viewpoint of the content item positioned within an extended reality (XR) environment; and
depicting a right eye portion of the content item, the right eye portion corresponding to a first right eye viewpoint of the content item within the XR environment; and
determining to use the content frame to provide a view of the content item within the XR environment, the view comprising a left eye view from a second left eye viewpoint different than the first left eye viewpoint and a right eye view from a second right eye viewpoint different than the first right eye viewpoint;
determining an adjustment to reduce an inconsistency associated with the left eye view and the right eye view, wherein a region of the content item in both the left eye view and the right eye view is depicted in only one of the left eye portion and the right eye portion of the content frame; and
presenting the left eye view and the right eye view based on the content frame and the adjustment.

14. The device of claim 13, wherein the multi-frame content data is associated with a first frame rate, and wherein the determining to use the content frame to provide the view of the content item within the XR environment is based on determining that the first frame rate is less than a target frame rate by the threshold amount.

15. The device of claim 13, wherein when the second left eye viewpoint and the second right eye viewpoint are rightward of the first left eye viewpoint and the first right eye viewpoint, the region of the content item in both the left eye view and the right eye view is depicted in only in the left eye portion of the content frame.

16. The device of claim 13, wherein when the second left eye viewpoint and the second right eye viewpoint are leftward of the first left eye viewpoint and the first right eye viewpoint, the region of the content item in both the left eye view and the right eye view is depicted in only in the right eye portion of the content frame.

17. The device of claim 13, wherein the operations further comprise blurring the left eye view and the right eye view.

18. The device of claim 13, wherein the operations further comprise displaying a left eye view from the first left eye viewpoint and a right eye view from the first right eye viewpoint.

19. The device of claim 13, wherein presenting the left eye view and the right eye view based on the content frame and the adjustment comprises presenting, for both the left eye view and the right eye view, only a region of the content item that is depicted in both of the left eye portion and the right eye portion of the content frame.

20. A non-transitory computer-readable storage medium storing program instructions that, when executed via a processor, cause performance of operations comprising:
receiving multi-frame content data from a source, the multi-frame content data comprising a content frame:
depicting a left eye portion of a content item, the left eye portion corresponding to a first left eye viewpoint of the content item positioned within an extended reality (XR) environment; and
depicting a right eye portion of the content item, the right eye portion corresponding to a first right eye viewpoint of the content item within the XR environment; and
determining to use the content frame to provide a view of the content item within the XR environment, the view comprising a left eye view from a second left eye viewpoint different than the first left eye viewpoint and a right eye view from a second right eye viewpoint different than the first right eye viewpoint;
determining an adjustment to reduce an inconsistency associated with the left eye view and the right eye view, wherein a region of the content item in both the left eye view and the right eye view is depicted in only one of the left eye portion and the right eye portion of the content frame; and presenting the left eye view and the right eye view based on the content frame and the adjustment.
